(19) United States
(12) Patent Application Publication
(10) Pub. No.: US 2007/0029351 A1
(43) Pub. Date: Feb. 8, 2007

(54) DRUM BUNG AND FILTER APPARATUS

(75) Inventor: Robert D. Benson, White Bear Lake, MN (US)

Correspondence Address: INSKEEP INTELLECTUAL PROPERTY GROUP, INC, 2281 W. 190TH STREET, SUITE 200, TORRANCE, CA, 90504, US

(73) Assignee: FluidTran, Inc.

(21) Appl. No.: 11/463,086

(22) Filed: Aug. 8, 2006

Related U.S. Application Data
(60) Provisional application No. 60/706,361, filed on Aug. 8, 2005.

(51) Int. Cl. B67D 5/60

(52) U.S. Cl. 222/464.1

(57) ABSTRACT

An apparatus for removing a fluid from a drum, the drum having a bung gap enclosing a bung and an elongate tube of sufficient length to reach the bottom of the drum. The tube is insertable into the bung through a cap, with the elongated tube sliding within the cap. The cap has threads adaptable to mate with the bung.

### BACKGROUND OF THE INVENTION

The present invention relates to an apparatus for removing fluid from a drum with a drying filter.

Drums that contain fluids such as engine oil come in 50 gal. drums which have a bung in one end. The fluid is typically dispensed from the drum by tipping the drum onto a side or by inserting a hose into the drum. However, it has been difficult in the past to get every last ounce of fluid out of the drum. Since some fluids, such as, for example, aircraft engine oil, may cost as much as $8 dollars per quart or more, it is important not to waste such a fluid.

Drums also contain a ¾ inch or similar breather hole to allow the fluid to be dispensed more easily. When this hole is opened, the fluid in the drum can be contaminated by particulates or moisture.

There is a need for an apparatus that addresses these problems.

### SUMMARY OF THE INVENTION

An apparatus for removing fluid from a drum, the drum having a bung gap enclosing a bung, the apparatus comprising an elongate tube of sufficient length to reach the bottom of the drum and insertable into the bung, the elongated tube being slidably received in a cap adapted to threadably mate with the bung.

### BRIEF DESCRIPTION OF DRAWINGS

FIG. 1 is a perspective view of a drum with the present invention attached thereto;

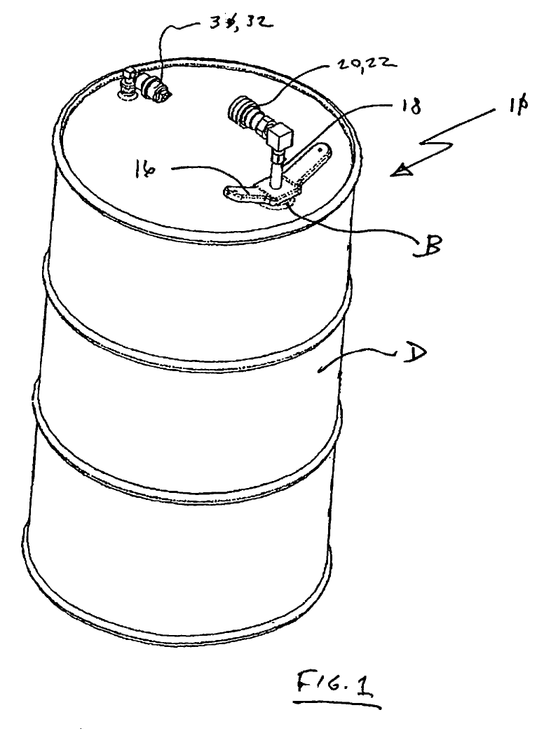

FIG. 2 is a side elevational view of a drum with the present invention attached thereto with some structure cut away;

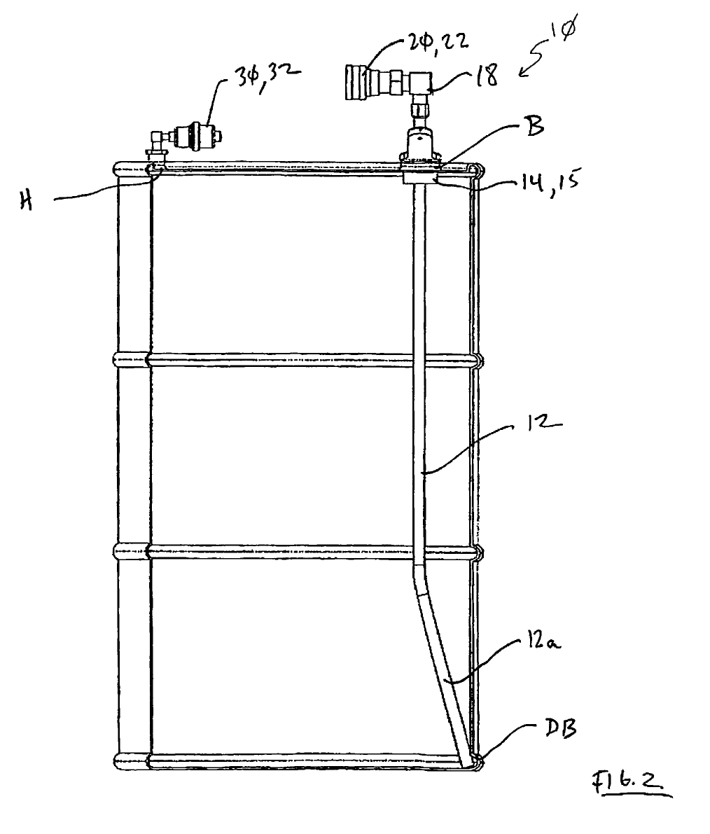

FIG. 3 is a perspective view of the apparatus of the present invention; and

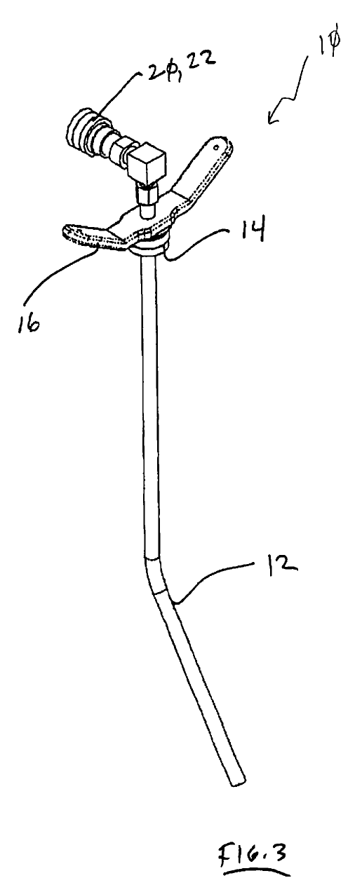

FIG. 4 is a perspective view of a drum with some structure cut away to show the present apparatus attached thereto.

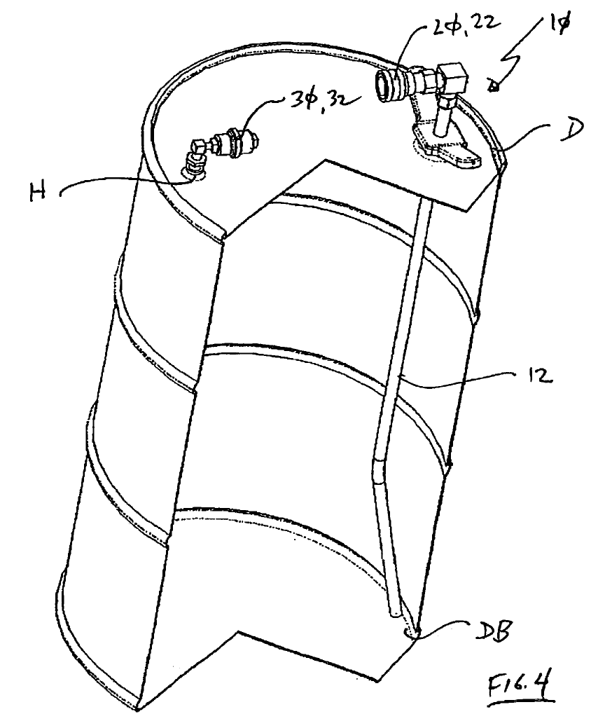

### DETAILED DESCRIPTION OF THE PREFERRED EMBODIMENT

The present invention is generally shown in the Figures as reference numeral 10.

The present invention is an apparatus 10 for removing fluid from a drum D, the drum D having a bung gap or bung hole (not shown) enclosing a bung B. Preferably the apparatus 10 is portable. The apparatus 10 further comprises an elongate tube 12 of sufficient length to reach the bottom DB of the drum D. The tube 12 is insertable into the bung B and is slidably received in a cap 14 adapted to threadably mate with the bung B.

Preferably, a large handle 16 is attached to the cap 14 to enable the cap 14 to be easily affixed to and removed from the bung B without the need for a wrench.

Near the end 12a of the elongated tube 12 distal from the cap 14, the tube 12 is bent at a slight angle. A 90 degree fitting 18 is attached to the tube 12 adjacent the cap such that one end 20 of the fitting 18 is approximately 180 degrees from the direction in which the tube 12 is bent. One of skill in the art would understand that the fitting 18 may be situated and/or set at a direction other than 180 degrees in relation to the tube 12, to achieve desired results. The 90 degree fitting 18 has a coupler 22 receiving a hose, as for example by a ¾ inch quick coupler.

The tube 12 is suitably mounted in the cap 14 by an O-ring to permit the tube 12 to be slid up and down in the cap 14 to adjust the tube 12 to reach the bottom DB of the drum D.

To use the apparatus 10, the cap of the bung B is removed. The tube 12 is inserted into the bung B, with the cap 14 threadably engaging the bung B and is tightened securely by a handle 16. The presence of a handle 16 on the apparatus 10 obviates the need for a separate bung removal tool, such as a wrench, which is typically necessarily employed to remove or secure a bung B. The tube 12 is slid downwards until the far end reaches the bottom DB of the drum. Then the tube 12 is turned within the cap 14 so that the end 20 of the 90 degree fitting 18 points away from the side of the drum, thus ensuring that the tip of the tube 12 (after the bend) points toward the side of the drum D. A hose is then mated with the coupler 22 and the fluid is pumped out of the drum D.

Optionally, a drying filter 30 may be attached to the breather hole H in the drum. The drying filter 30 may contain a dessicant filter or coalescing filter 32. Any air coming into the drum through the breather hole H can be filtered to remove contaminants and moisture,

The present invention may be embodied in other specific forms without departing from the spirit or essential attributes thereof, and it is therefore desired that the present embodiment be considered in all respects as illustrative and not restrictive.

What is claimed is:

1. Apparatus for removing fluid from a drum, the drum having a bung gap enclosing a bung, the apparatus comprising an elongated tube of sufficient length to reach the bottom of the drum and insertable into the bung, the elongated tube being slidably received in a cap adapted to threadably mate with the bung.

2. The apparatus of claim 1, wherein said elongated tube comprises an angular tip.

3. The apparatus of claim 1, further comprising a handle.

4. The apparatus of claim 2, wherein said elongated tube operably connects with a fitting attached to said tube at a location adjacent to said cap.

5. The apparatus of claim 4, wherein said fitting is oriented at a 90 degree angle to said cap and oriented in a direction approximately 180 degrees from the angular tip of said elongated tube.

6. The apparatus of claim 1, wherein the drum having a bung gap enclosing a bung comprises the drum further including a filter.

7. A method for efficient removal of fluid from a drum, comprising:
providing an elongated tube that is removably insertable into a drum;
providing a cap for said drum that slidably receives said elongated tube;
inserting said elongated tube in a manner sufficient to remove substantially all of said fluid from said drum; and
removing said fluid.

8. The method of claim 7, wherein providing a cap for said drum comprises providing a cap for said drum that is threadably matable with said drum.

9. The method of claim 7, wherein providing a cap for said drum that is threadably matable with said drum comprises providing a cap for said drum that is threadably matable with a bung of said drum.

10. The method of claim 8, wherein providing a cap for said drum that slidably receives said elongated tube comprises providing a cap for said drum that is affixable to said drum with a handle.

11. The method of claim 7, wherein inserting said elongated tube in a manner sufficient to remove substantially all of said fluid from said drum comprises inserting said elongated tube in a manner sufficient to remove substantially all of said fluid from said drum whereby the tip of said elongated tube is angled to the lower-most portion of said drum.

12. A method of removing fluid from a drum that minimizes exposure of moisture and contaminants to said fluid.

13. The method of claim 12, wherein minimizing exposure of moisture and contaminants to said fluid comprises minimizing exposure of moisture and contaminants to said fluid by attaching a filter to a breather hole of said drum.

14. The method of claim 13, wherein attaching a filter to a breather hole of said drum comprises attaching a dessicating filter to said breather hole of said drum.

15. The method of claim 13, wherein minimizing exposure of moisture and contaminants to said fluid comprises minimizing exposure of moisture and contaminants to engine oil.

16. The method of claim 12, wherein removing fluid from a drum that minimizes exposure of moisture and contaminants to said fluid comprises removing fluid from a drum with an apparatus comprising an elongated tube, slidably insertable into a bung cap that is threadably matable with a drum bung.

17. The method of claim 16, wherein removing fluid from a drum with an apparatus comprising an elongated tube, slidably insertable into a bung cap that is threadably matable with a drum bung further comprises a drum operably connected with a filter.
